(19) United States
(12) Patent Application Publication
(10) Pub. No.: US 2025/0337632 A1
(43) Pub. Date: Oct. 30, 2025

(54) DATA PATH FAILURE ROOT CAUSE IDENTIFICATION WITH MODIFIED PACKETS

(71) Applicant: Palo Alto Networks, Inc., Santa Clara, CA (US)

(72) Inventors: Kim Le, San Jose, CA (US); Chethan Channappa, San Jose, CA (US)

(21) Appl. No.: 18/651,431

(22) Filed: Apr. 30, 2024

(51) Int. Cl. H04L 41/0631; H04L 41/0668

(52) U.S. Cl. CPC H04L 41/0631; H04L 41/0668

(57) ABSTRACT

A data path root cause analysis application (“application”) identifies a node in a computing fabric as a root cause of failure in a data path. Based on detecting a failure in the data path, the application performs a reverse traversal starting at the last node in the data path. At each node in the reverse traversal, the application sends modified packets through the data path with custom headers comprising flags to exit the data path at the current node. When modified packets successfully exit the data path at a current node in the reverse traversal, the application identifies a previous node as the root cause of failure. The node identified as a root cause of failure is then remediated to allow further communication of packets through the data path.

### BACKGROUND

The disclosure generally relates to transmission of digital information (e.g., CPC class H04L) and network arrangements, protocols, or services for addressing or naming (e.g., subclass H04L 61/00).

A computing fabric, often referred to as a “fabric” in the context of computing and networking, is an advanced, integrated architecture that enables interconnected nodes to share resources efficiently. This concept is crucial in distributed computing systems, high-performance computing, cloud computing, and data center environments. The term “fabric” metaphorically describes the seamless, flexible interconnection of computing resources, such as servers, storage units, and network devices, to create a cohesive and efficient system. Advantages of fabric computing include scalability due to ease of addition and removal of nodes, high interconnectivity between nodes which facilitates rapid data transfer and distributed computing, dynamic allocation and optimization of resources, resilience and fault tolerance against failure of individual nodes, and management tools that automate monitoring, control, and optimization.

### BRIEF DESCRIPTION OF THE DRAWINGS

Embodiments of the disclosure may be better understood by referencing the accompanying drawings.

FIG. 1 is a schematic diagram of an example system for identifying a root cause of failure in a data path of a computing fabric using modified packets.

FIG. 2 is a flowchart of example operations for identifying a node in a computing fabric as a root cause of failure in a data path.

FIG. 3 is a flowchart of example operations for monitoring node health in a computing fabric with modified packets.

FIG. 4 is a flowchart of example operations for communicating a modified packet through a data path of a computing fabric.

FIG. 5 depicts an example computing fabric system with a data path root cause analysis application.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Due to the high interconnectivity and complex network topology of computing fabrics, root cause analysis for failure of nodes can be difficult. Despite resilience of computing fabrics against individual node failure, as failures proliferate remediation becomes more necessary. Typical solutions involve power cycling one or more hardware or software components (e.g., line cards) where the failure occurs and, if the failure persists, replacing the one or more hardware components. The present disclosure presents a methodology and protocol for identifying a node in a computing fabric as a root cause of failure for a corresponding data path, allowing for remediation of that node without wholesale replacing a corresponding hardware or software component. Nodes in the computing fabric are configured to handle modified packets with custom packet headers that indicate identifiers of nodes in data paths of each packet, signatures in the packets, and flags that at least indicate handling of the packets at each node in the data path.

Based on detecting a failure in the data path of the computing fabric, a data path root cause analysis application (“application”) analyzes the data path for a root cause of failure by performing a reversed traversal of the data path. For each node in the reverse traversal of the data path starting at the last node in the data path, the application sends modified packets with flags indicating exiting the data path at the current node in the traversal. The application then determines whether the modified packets successfully exit the data path at the current node. The modified packets have corresponding signatures so that the application can verify that the packets the application receives from the current node are the modified packets. If, at a current node during the traversal, the packets successfully exit the data path, the application can identify at least the preceding node as a root cause of failure. This is because the data path up to and including the current node does not have a failure whereas the data path up to the preceding node in the reverse traversal, which is the subsequent node to the current node in the data path because the traversal is in reverse, has a failure. The application performs a remediation action(s) on the node identified as the root cause of the failure. If the failure persists, the application can perform additional reverse traversals on the remaining nodes in the data path after the remediated node for further remediation of the data path when multiple nodes are a root cause of failure.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

The term “data path” as used herein refers to a sequence of nodes (e.g., hardware and/or software components) in a computing fabric that allow data to flow from a source node to a destination node in the sequence of nodes. Although each data path is associated with a source and a destination node in the computing fabric, a source and destination node can be associated with multiple data paths, for instance to facilitate load balancing nodes within each data path.

### Example Illustrations

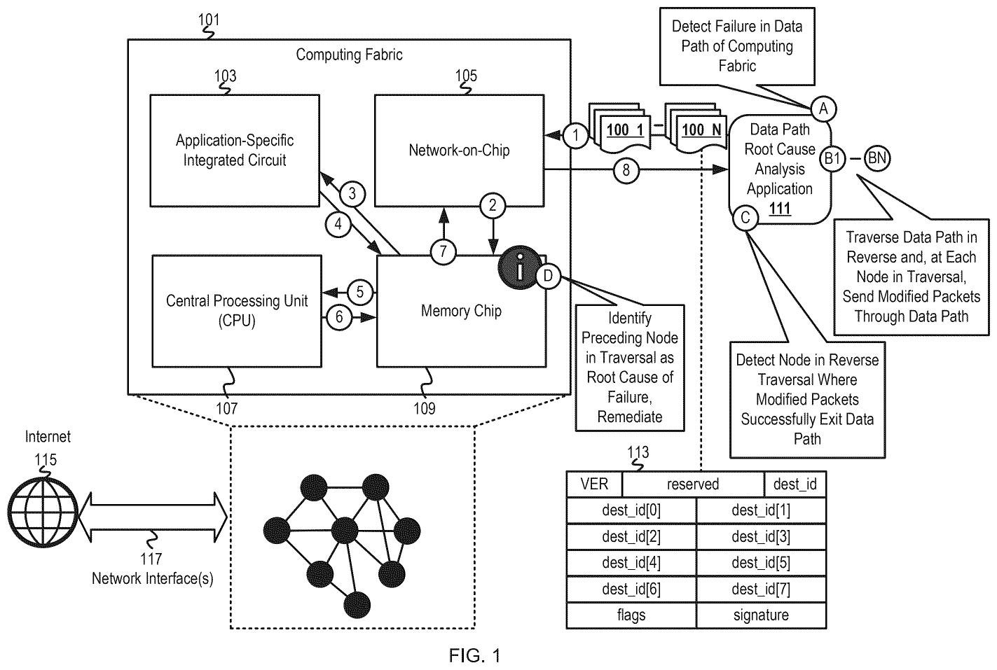

FIG. 1 is a schematic diagram of an example system for identifying a root cause of failure in a data path of a computing fabric using modified packets. FIG. 1 depicts a root cause analysis application (“application”) 111 identifying a root cause of failure in a computing fabric 101 comprising an application-specific integrated circuit (“ASIC”) 103, a network-on-chip 105, a central processing unit (“CPU”) 107, and a memory chip 109 as nodes. The computing fabric 101 is depicted with the integrated circuits (hereafter “chips”) 103, 105, 107, and 109 as nodes as an example illustration. In other layouts, the computing fabric 101 can comprise additional or alternative chips, peripherals, etc. More generally, nodes in the computing fabric 101 can comprise any hardware or software modules. For instance, the computing fabric 101 can comprise line cards (e.g., data processing cards, network processing cards, management processing cards, etc.) connected to fabric modules (e.g., switch fabric cards) oriented orthogonally to the line cards in a rack mounted hardware configuration. The fabric modules orchestrate architecture of the computing fabric 101 via connections between the line cards along data paths. Each of the line cards and fabric modules can comprise one or more instances of the chips 103, 105, 107, and 109. The computing fabric 101 is depicted as having a connection with the Internet 115 via a network interface(s) 117, for instance when the computing fabric 101 comprises a firewall monitoring network traffic.

FIG. 1 is annotated with a series of numbers 1-8 and letters A, B1-BN, C, D. The numbers 1-8 denote an order of a sequence of nodes in a data path of the computing fabric 101 where a failure has occurred, whereas the letters A, B1-BN, C, D represent stages of operations performed by the application 111 for identifying a root cause of the failure. Each stage represents one or more operations. Although these stages are ordered for this example, the stages illustrate one example to aid in understanding this disclosure and should not be used to limit the claims. Subject matter falling within the scope of the claims can vary from what is illustrated.

At stage A, the application 111 detects a failure in a data path of the computing fabric 101. For instance, when the computing fabric 101 corresponds to a firewall, the application 111 can determine that the computing fabric 101 failed to forward traffic to its intended destination. In this example, an endpoint device whose traffic is being monitored by the computing fabric 101 can determine that expected responses from outgoing network traffic (e.g., HyperText Transfer Protocol (HTTP) responses) were not received and can communicate indications of the failure to the computing fabric 101. Failures can be detected by a domain-level expert, e.g., a network administrator manually inspecting traffic logs when the computing fabric 101 does not perform as expected. In other embodiments, for instance when the computing fabric 101 is a server mounted appliance, one or more light-emitting diodes (LEDs) can turn on when a failure of a node in the computing fabric 101 occurs. Based on the detected failure, the application 111 identifies a data path in the computing fabric 101 corresponding to the failure. For instance, the application 111 can identify the data path based on a source and destination IP address of packets where the failure occurred. The computing fabric 101 can have a node that identifies data paths for incoming packets and modifies those packets to add a data path based on source and destination of those packets. This node can be used to identify the data path corresponding to the failure. In a system with an LED to indicate failure, the data path can be identified as a data path whose failure corresponds to the active LED. In some embodiments, an orchestrator or other management component of the computing fabric 101 can be configured to identify the data path.

At each of the stages B1-BN, the application 111 traverses the data path in reverse and, at each node in the traversal, sends modified packets 100_1-100_N through the data path. For the ith stage, modified packets 100_i comprise packets with a custom header such as example header 113. Example header 113 comprises a “VER” header field, a “reserved” header field, an “ID” header field, identifiers for each node in the data path labelled as dest_id[j] for the jth node, flags, and a signature. In the depicted example, dest_id[0] is chip 105, dest_id[1] is chip 109, dest_id[2] is chip 103, dest_id[3] is chip 109, dest_id[4] is chip 107, dest_id[5] is chip 109, dest_id[6] is chip 105, and dest_id[7] is an external interface for the computing fabric 101 (e.g., network interface 113). A flag for each of the modified packets 100_i indicates exiting the data path at the ith node. The “VER” and “reserved” fields in the example header 113 can specify different protocol versions and different options to enable for the modified packets 100_1-100_N, allowing for flexible usage that can build on top of existing protocols.

As illustrated in this example, multiple nodes in the data path can correspond to a same software/hardware module when a module is visited multiple times in the data path. The data path in FIG. 1 is depicted for a single set of chips (e.g., a line card). However, in other embodiments, the data path can traverse multiple sets of chips or other software/hardware modules, for instance prior to the node labelled number 1 and subsequent to the node labelled number 8 in the data path.

For the depicted data path, the application 111 starts the reverse traversal at the last node in the data path, i.e., the chip 105. The application 111 generates the modified packets 100_1 by adding the data path in corresponding fields, adding a signature unique to each packet so that the application 111 can track the modified packets 100_1 when they exit the data path, and adding a flag that indicates the modified packets should be forwarded to the application 111 when they reach the chip 105. The application 111, which executes in the user space, sends the modified packets 100_1 to the computing fabric 101 in the kernel space. The computing fabric 101 then processes the modified packets 100 at each of the chips 103, 105, 107, 109 according to the data path specified by the custom packet headers in the kernel space. Each of the chips 103, 105, 107, 109 is configured to parse the custom packet headers and handle the modified packets 100_1 according header field values extracted therefrom. As an example, when the jth node in the data path receives a packet, the jth node can inspect its header to determine the number node for the packet in the data path (j), for instance as stored in a pointer, field, or other data structure of the packet header. The jth node can then inspect flags in the header to determine whether to forward the packet to the application 111. If the flags do not indicate forwarding or other handling instructions, the jth node can then update the “dest_id” field, which will currently be dest_id[j-1], with dest_id[j].

Because there is a failure in the data path, the application 111 expects to not receive any of the modified packets 100_1 at the first node in the traversal. The application 111 inspects signatures of any packets it receives subsequent to communicating the modified packets 100_1 to determine if any of those packets are in the modified packets 100_1. The application 111 continues inspecting packets it receives until a timeout occurs. If, at the first node in the traversal, the application 111 receives the modified packets 100_1 from the last node in the traversal, the application 111 can generate an alert that the failure was a false positive and that the data path is functional and stop subsequent operations for the traversal.

At each subsequent ith node in the traversal, the application 111 updates the modified packets 100_i with a flag indicating forwarding of the modified packets 100_i to the application at the ith to last node in the traversal and sends the modified packets 100_i to the computing fabric 101.

At stage C, the application 111 detects a node in the traversal where the modified packets 100_i successfully exited the data path, i.e., by inspecting packets received subsequent to communicating the modified packets 100_i to the computing fabric 101 and determining that the received packets have signatures that match signatures of the modified packets 100_i. In the depicted example, the application 111 detects the second node (i.e., chip 107) in the data path as the node in the traversal where the modified packets 100 successfully exited the data path. It is possible, for instance when the first node in the data path has a failure, that during all of the iterations B1-BN, the application 111 does not detect a node in the traversal where the modified packets 100 successfully exited the data path. In this case, the application 111 identifies the first node in the data path as the root cause of the failure.

At stage D, the application 111 identifies the preceding node (hereinafter “failure node”) in the (reverse) traversal as the root cause of failure. The failure node in the reverse traversal is the next node in the data path, in this instance the sixth node (i.e., chip 109). In this example, although there is no failure in the chip 109 at the second node in the data path, there is a failure in the chip 109 at the sixth node in the data path. This could indicate that the chip 109 has a partial failure or is not correctly configured, for instance, that there is a failure in the connection between the chip 107 and the chip 109. The application 111 performs a remediation action on the failure node. For instance, the application 111 can replace the failure node, replace a line card containing the failure node, power cycle the failure node (or a hardware module comprising the failure node), troubleshoot the failure node, etc. Remediation action can depend on a type of the failure node, for instance hardware nodes may require replacement whereas software nodes may be fixed with troubleshooting.

In some embodiments, after the remediation of the failure node, the application 111 may still detect a failure in the data path, e.g., when multiple nodes are a root cause of the failure. In this case, the application 111 determines that the additional failure node(s) are subsequent to the failure node in the data path because, at stage C, the preceding nodes to the failure node were able to exit the modified packets 100 from the data path. Thus, the application 111 performs an additional traversal of a subset of the data path subsequent to the failure node as described in the foregoing, and this process occurs until the data path no longer has a failure.

The application 111 operates in the control plane, whereas the chips 103, 105, 107, 109 operate in the data plane when receiving, handling, and forwarding packets according to their packet headers. In general, when the computing fabric 101 receives packets (e.g., modified packets 100), an orchestration or management component operating in the control plane at the computing fabric 101 can determine the data path that those packets should travel through. For the example of the modified packets 100, the data path is explicitly provided by custom packet headers added by the application 111. More generally, packet headers may not specify a data path and the orchestration or management component may determine the data path based on metadata from packet headers (e.g., source and destination IP addresses), load balancing across the computing fabric 101, known faulty or failed nodes, etc.

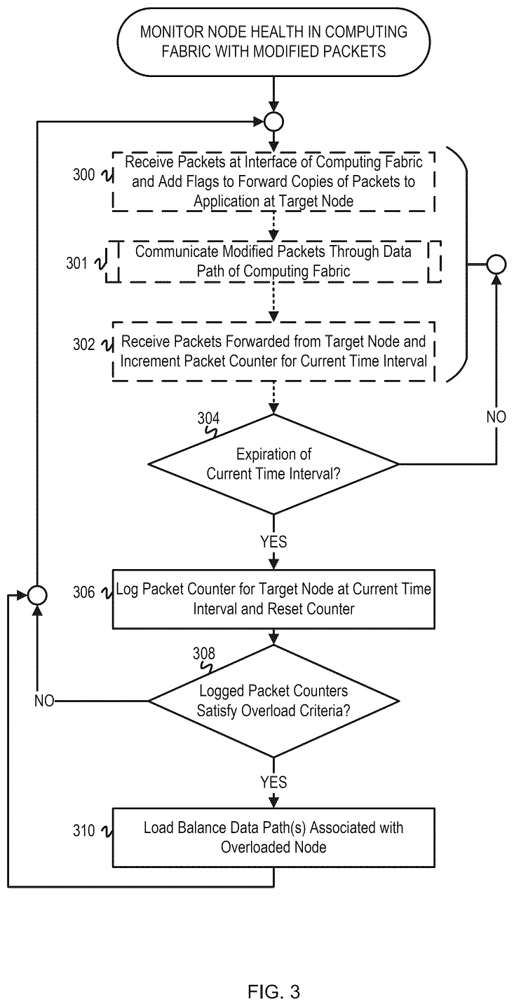

The example embodiments in FIG. 1 depict a particular custom packet header format used to identify a node as a failure in a data path. Other formats for packet headers are anticipated depending on corresponding protocols, for instance by modifying existing protocols or building custom protocols specific to the computing fabric 101. Moreover, the same methodology for identifying a node as a cause of root failure in a data path can be used to track load on a node and/or data path for the purposes of load balancing. For instance, the application 111 (or other component operating at the network interface(s) 117) can add flags to headers of packets entering the computing fabric 101 that indicate forwarding a copy of those packets when a node with a particular identifier is reached and can track forwarded copies of the packets to determine load as a frequency of forwarded packets within time intervals. Operations for tracking load on a target node in a computing fabric are described in greater detail in reference to FIG. 3.

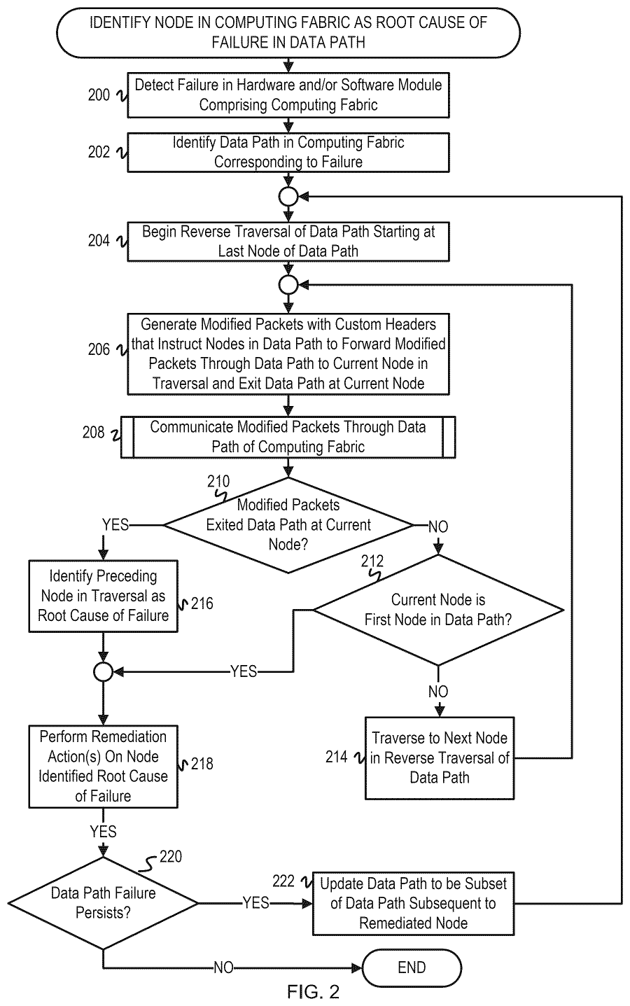

FIGS. 2-4 are flowcharts of example operations for identifying a node as a root cause of failure in a data path of a computing fabric and monitoring node health in the computing fabric using modified packets. The example operations are described with reference to a data path root cause analysis application (“application”), an interface of the computing fabric, and nodes in a computing fabric for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for identifying a node in a computing fabric as a root cause of failure in a data path. At block 200, the application detects a failure in a hardware and/or software module comprising a computing fabric. For instance, the hardware and/or software module can comprise a firewall, router, or other networking component. The application can detect the failure based on an endpoint device communicating packets to the hardware and/or software module (e.g., HTTP requests to the Internet) and not receiving expected responses (e.g., HTTP responses). The failure can be detected by a user of the endpoint device attempting to connect to the Internet and can be communicated to the application via a user interface. Alternatively, a network administrator for a network comprising the endpoint device can inspect traffic logs or other analytics to detect failures, failures can be detected by a process running on the endpoint device when it fails to receive HTTP responses, etc.

At block 202, the application identifies a data path in the computing fabric corresponding to the failure. The data path can depend on the source and/or destination of the data path (e.g., source/destination IP addresses for packets transmitted through the data path, source/destination nodes in the computing fabric, etc.). The application or other orchestrator/management component can identify the data path by inspecting metadata associated with the failure such as sources and destinations of packets travelling through the data path, metadata of packets communicated by an endpoint device or other component that resulted in detecting the failure, etc.

At block 204, the application begins a reverse traversal of the data path in the computing fabric corresponding to the failure. The reverse traversal begins at the last node in the data path and traverses each successive preceding node in reverse order. The application can be configured with an ordered list of nodes in the data path or can communicate with a component that orchestrates data paths in the computing fabric (e.g., a fabric switch card) to retrieve the ordered list of nodes.

At block 206, the application generates modified packets with custom headers that instruct nodes in the data path to forward the modified packets through the data path to the current node in the traversal and exit the data path at the current node. The application is configured to receive the modified packets at an interface (e.g., a network interface) when they exit the data path. The custom headers comprise an ordered list of nodes in the data path, an identifier of the next node in the data path (initialized as the first node), a pointer or other data structure indicating the number of the current node in the data path, a flag that instructs the current node in the traversal to send the modified packets to the application or other interface and not send the modified packets to the next node in the data path, a unique signature for each of the modified packets, etc. For instance, the flag can comprise an identifier in a specified field that indicates exiting the data path at that node.

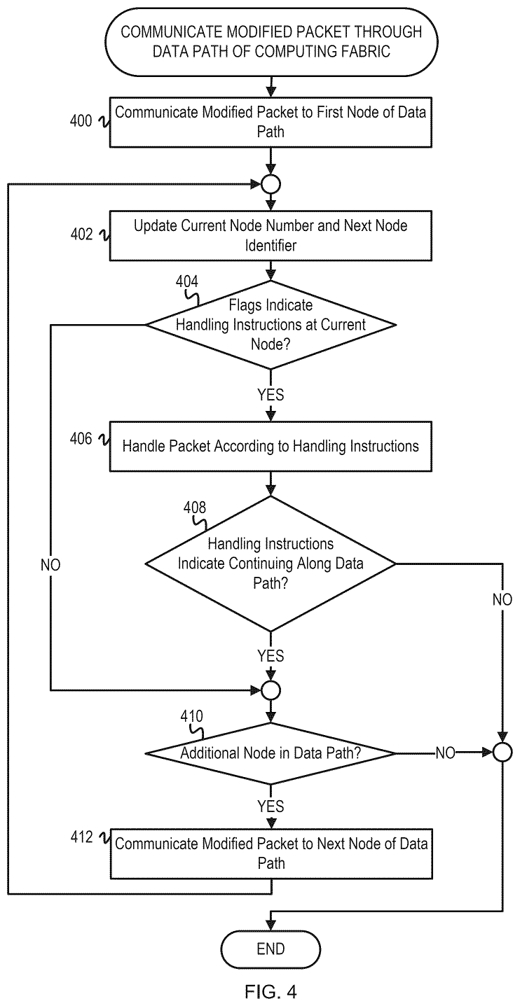

At block 208, the application sends the modified packets to a first node in the data path and the nodes in the data path send the modified packets through the data path of the computing fabric according to the custom headers. Each node parses the custom headers and handles packets according to corresponding flags, next node identifiers, etc. Each node is configured to handle modified packets according to these custom headers. For instance, the computing fabric can comprise proprietary chips that are configured accordingly. The operations at block 208 for each modified packet are described in further detail in reference to FIG. 4.

At block 210, the application determines if the modified packets exited the data path at the current node. For instance, a component in the kernel space of the computing fabric can receive packets exiting the computing fabric and can forward, to the application in the user space, exiting packets having headers that indicate the most recent visited node as the current node in the traversal. The application may receive many packets from many sources (for instance, as it monitors multiple nodes, data paths, etc.) and identifies the modified packets based on their signatures. The criteria that the modified packets exited the data path at the current node can comprise that all or a threshold amount (e.g., 99%) of the modified packets exited the data path. If the modified packets exited the data path, operational flow proceeds to block 216. Otherwise, operational flow proceeds to block 212.

At block 212, the application determines the current node is the first node in the data path. If the current node is the first node, then the application identifies the first node as the root cause of failure and operational flow skips to block 218. Otherwise, operational flow proceeds to block 214.

At block 214, the application traverses to the next node in the reverse traversal of the data path, i.e., the preceding node to the current node. Operational flow returns to block 206.

At block 216, the application identifies the preceding node in the traversal (i.e., the next node in the data path after the current node) as the root cause of failure. The application is able to identify the preceding node as the root cause of failure because, in the previous iteration in the reverse traversal the modified packets failed to exit the data path whereas at the current iteration in the reverse traversal the modified packets successfully exited the data path.

At block 218, the application performs a remediation action(s) based on the node identified as the root cause of failure. For instance, the application can power cycle the identified node, replace the identified node with a functional version, troubleshoot the identified node, etc.

At block 220, the application determines whether the data path failure persists. For instance, the application can send additional modified packets to the data path comprising custom headers with flags instructing nodes to forward the packets to the application at the last node of the data path. The application can then determine whether signatures of packets received by the application match signatures of the additional modified packets. If the data path failure persists, operational flow proceeds to block 222. Otherwise, the operational flow stops.

At block 222, the application updates the data path to be the subset of the data path subsequent to the remediated node. During the reverse traversal, the modified packets successfully exited the subset of the data path prior to the remediated node. Thus, the node(s) that is a root cause of the persistent failure is subsequent to the remediated node in the data path. Operational flow returns to block 204 for an additional reverse traversal with the updated data path.

FIG. 3 is a flowchart of example operations for monitoring node health in a computing fabric with modified packets. The application monitors the health of a target node in the computing fabric. The target node can be chosen as a node that frequently experiences failures or delays or a node that is expected to have high load in the computing fabric.

Blocks 300, 301, and 302 are depicted with dashed lines and connected with dashed lines to indicate that these operations can occur in parallel across nodes being monitored and across modified packets being transmitted through the data path in the computing fabric. These operations increment counters corresponding to load at the node until time intervals for monitoring node health elapse, when the counters are reset. The operations in FIG. 3 continue until an external trigger (e.g., a network administrator stops monitoring health of the target node) occurs.

At block 300, the computing fabric receives packets at an interface and the application adds flags to the packets that instruct nodes in the computing fabric to forward copies of the packets to the application at the target node being monitored. The computing fabric is in a firewall, the interface can comprise a network interface receiving packets from a private network to communicate to the Internet. The flags can indicate an identifier of the target node in a field. The field can correspond to instructions for forwarding a copy of a modified packet to the interface or application and also communicating the modified packet to the next node in the data path. This field can comprise a different field from the field in the foregoing used to instruct the target node to forward the modified packet to the interface or application without communicating the modified packet to the next node in the data path. In embodiments, the application can add flags to all packets received at the interface or can only add flags to packets that will be transmitted through a data path comprising the target node. The interface can be configured to forward packets that will follow a data path comprising the target node to the application to modify their headers prior to communicating these packets to the first node in the data path.

At block 301, the application or interface of the computing fabric sends the modified packets to first nodes in corresponding data paths of the computing fabric and the nodes of the computing fabric send the modified packets through each respective data path. The target node can be included in multiple data paths and, as such, the application or interface can send different modified packets to different first nodes in data paths according to next node identifiers of custom packet headers in the modified packets. The operations at block 301 for each modified packet are described in further detail in reference to FIG. 4.

At block 302, the application receives packets forwarded from the target node and increments a packet counter for a current time interval for monitoring health of the target node. The application can maintain multiple counters for each node being monitored.

At block 304, the application determines if a current time interval for monitoring health of the target node has expired. For instance, the time interval can comprise a fixed schedule (e.g., every minute, hour, day, etc.) or can vary based on expected load to monitor more frequently during times of day and/or days where load on the target node is expected to spike. Time intervals can also vary by type of target node, for instance to be more frequent when the target node is a node that experiences higher than average load. If the current time interval has expired, operational flow proceeds to block 306. Otherwise, operational flow returns to block 300, 301, and 302 to monitor additional packets at the target node.

At block 306, the application logs the packet counter for the target node at the current time interval and resets the counter. The application can periodically delete old packet counter logs for the target node.

At block 308, the application determines whether the logged packet counters for the target node satisfy overload criteria. The overload criteria can comprise that the most recently logged packet counter is over a threshold counter corresponding to overload for the target node, that an average of past-N packet counters exceeds a threshold counter, etc. If the logged packet counters satisfy the overload criteria, operational flow proceeds to block 310. Otherwise, operational flow returns to block 300.

At block 310, the application or other orchestrator of the computing fabric

(e.g., a fabric switch card) load balances a data path(s) associated with the overloaded node. For instance, the application or orchestrator can reroute packets to different data paths, can reroute existing data paths around the target node, etc.

The operations in FIG. 3 are depicted for monitoring load over time at the target node. Alternatively, the application can monitor latency at a node, latency along a data path, etc. with substantially similar operations with the exception that instead of maintaining counters for modified packets, the application tracks time stamps for the modified packets when they enter and exit a data path or node.

FIG. 4 is a flowchart of example operations for communicating a modified packet through a data path of a computing fabric. The operations in FIG. 4 are performed by nodes in the data path that are configured to handle a custom header in the modified packet. The custom header includes flags that instruct nodes in the computing fabric for how to handle the modified packet.

At block 400, the application sends the modified packet to a first node in the data path. The application can identify the first node in the data path based on a next node identifier in a custom header of the modified packet. The application performs operations in the user space and control plane, whereas the nodes in the data path perform operations in the kernel space and data plane. Accordingly, the application can process the modified packets with various protocols in the Internet protocol suite (e.g., application layer protocols, presentation layer protocols, session layer protocols, etc.) prior to generating the modified packets so that they can be handled by protocols that operate in the kernel space/data plane. In some embodiments, packets received by the computing fabric will already have headers for protocols that operate in the kernel space/data plane and these operations can be omitted.

At block 402, the current node updates a data structure tracking the current node number and a destination node identifier in the custom header of the modified packet. The current node number can comprise a field that indicates a number of the current node in the data path (e.g., initialized at 1 or 0 depending on indexing), a pointer to an entry in a list of node identifiers for a data path of the modified packet, etc. The current node can determine the next node identifier from the list of node identifiers in the custom header based on the current node number.

At block 404, the current node determines whether flags in the custom header indicate handling instructions at the current node. For instance, certain flags can indicate forwarding the modified packet to the application with or without communicating the modified packet to the next node in the data path or discarding the modified packet entirely. The flags can identify the node in the computing fabric where the handling occurs according to its number in the data path or using an identifier of the node. If the flags indicate handling instructions at the current node, operational flow proceeds to block 406. Otherwise, operational flow proceeds to block 410.

At block 406, the current node handles the packet according to the handling instructions. For instance, the current node can forward the packet, discard the packet, copy the packet, modify the custom header, etc.

At block 408, the current node determines whether the handling instructions indicate continuing along the data path. For instance, when the application is monitoring node health (FIG. 3), the handling instructions can indicate forwarding the modified packet to the application while also communicating the modified packet to the next node in the data path. Conversely, when the application is identifying a node as a root cause of failure in a data path the handling instructions can indicate forwarding the modified packet to the application without communicating the modified packet to the next node in the data path. If the node determines that the handling instructions indicate continuing along the data path, operational flow proceeds to block 410. Otherwise, the operational flow in FIG. 4 stops. Although depicted as a tangible operation performed at the current node, in embodiments the current node can be configured to proceed to block 410 or stop operations in FIG. 4 according to which field of the custom header included the handling instructions.

At block 410, the current node determines whether there is an additional node in the data path. For instance, the current node can inspect a list of node identifiers of the data path in the custom header and determine whether the current node number is less than the number of node identifiers in the list. If there is an additional node in the data path, operational flow proceeds to block 412. Otherwise, the operational flow in FIG. 4 stops.

At block 412, the current node sends the modified packet to the next node in the data path. The channel of communication between the current node and the next node can comprise a low-latency, high-bandwidth connection allowing for efficient processing of packets through the computing fabric. Operational flow returns to block 402.

### Variations

The example packet headers are depicted with “VER” fields, reserved fields, next node identifier fields, data path node identifier fields, flag fields, and signature fields in that order. Other formats and ordering of fields in custom headers are anticipated as long as nodes in the computing fabric are configured to handle the custom headers. In some embodiments, nodes in the computing fabric are configured to handle multiple types of custom headers in modified packets. The term “modified packets” refers to any packets with modified headers. Alternatively, these can be referred to “diagnostic packets” according to their purpose for diagnosing root causes of failure or evaluating node health in computing fabrics.

The foregoing refers to performing a reverse traversal of data paths to identify root causes of failure. Alternatively, reverse traversal can be viewed as identifying the sequence of nodes in the data path, and at each iteration of the reverse traversal, successively shortening the data path. For each successive shortening of the sequence of nodes, the data path root cause analysis application transmits diagnostic packets with flags to exit the data path at the last node in the shortened sequence of nodes to determine whether the diagnostic packets exit successfully.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 300, 301, and 302 can be performed in parallel or concurrently across modified packets, target nodes, and corresponding data paths. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), service ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

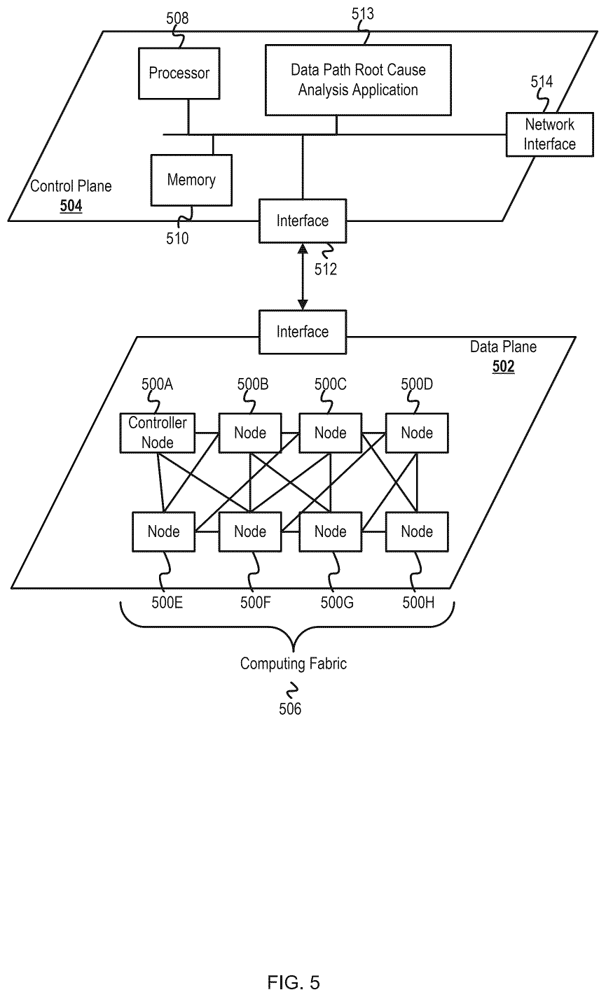

FIG. 5 depicts an example computing fabric system with a data path root cause analysis application. The computing fabric system is divided into a control plane 504 controlling data flow through the computing fabric system and a data plane 502 that comprises a computing fabric 506. The computing fabric 506 comprises a controller node 500A and nodes 500B-500H. The controller node 500A orchestrates data paths through nodes of the computing fabric 506. Each of the nodes 500A-500H can comprise a machine-readable medium, a processor, a line card, an ASIC, a system on a chip, etc. Although depicted as 8 nodes with a particular network topology, the computing fabric 506 can vary in terms of number of nodes and available pairwise connections between nodes that define the network topology. The control plane 504 of the computing fabric 506 comprises a processor 508, memory 510, a network interface 514, and an interface 512 between the control plane 504 and the data plane 502. The interface 512 allows for communication between the control plane 504 and the data plane 502, for instance communication of packets to and from the data plane 502 for processing by the computing fabric 506 and communication of instructions for orchestration of the computing fabric 506 to the controller node 500A. The system also includes a data path root cause analysis application (“application”) 513 in the control plane 504. The application 513 identifies a node (e.g., one of the nodes 500A-500H) as a root cause of failure in a data path of the computing fabric 506. Based on detecting a failure in the data path of the computing fabric 506, the application 513 traverses the data path in reverse for root cause analysis. At each node in the reverse traversal, the application 513 sends modified packets to the data path with flags to exit the data path at the current node. When the application 513 determines that modified packets successfully exited the data path at a current node in the reverse traversal, the application identifies a next node to the current node as a root cause of failure. Any one of the previously described functionalities may be partially (or entirely) implemented in hardware. For example, the functionality may be implemented with an application specific integrated circuit, in a co-processor on a peripheral device or card, by a processor running the application 513, etc. Further, realizations may include fewer or additional components not illustrated in FIG. 5 (e.g., video cards, audio cards, additional network interfaces, peripheral devices, etc.).

1. A method comprising:
detecting a failure in a data path in a data plane, wherein the failure comprises a failure to send packets through the data path, wherein the data path comprises a plurality of nodes; and
traversing the data path in reverse order to identify a root cause of the failure, wherein traversing the data path in reverse order comprises, at each node in the plurality of nodes in the traversal,
sending packets through a subset of the plurality of nodes, wherein the subset of the plurality of nodes comprises the node and those of the plurality of nodes prior to the node in the data path;
based on determining that the packets are successfully transmitted through the subset of the plurality of nodes, identifying a subsequent node to the node in the data path as the node being the root cause of the failure; and
based on determining that the packets are not successfully transmitted through the subset of the plurality of nodes, traversing to a preceding node in the data path.

2. The method of claim 1 further comprising, at each node in the traversal, determining whether the packets are successfully transmitted through the subset of the plurality of nodes.

3. The method of claim 2, wherein sending the packets through the subset of the plurality of nodes at each node in the traversal comprises sending the packets through the subset of the plurality of nodes in kernel space, wherein determining, at each node in the traversal, whether the packets are successfully transmitted through the subset of the plurality of nodes comprises determining, in user space, whether the packets are successfully transmitted through the subset of the plurality of nodes.

4. The method of claim 2, wherein determining, at each node in the plurality of nodes in the traversal, whether the packets are successfully transmitted through the subset of the plurality of nodes comprises matching signatures of packets exiting the data path at the node with signatures of the packets that were transmitted through the subset of the plurality of nodes.

5. The method of claim 1, further comprising, at each node in the plurality of nodes in the traversal, prior to sending the packets through the subset of the plurality of nodes, modifying the packets to have headers with flags indicating exiting the data path at the node.

6. The method of claim 1, wherein each node of the plurality of nodes comprises one or more chips.

7. The method of claim 6, wherein the one or more chips comprise at least one of a central processing unit, an application-specific integrated circuit chip, a memory chip, and a network-on-chip.

8. The method of claim 1, further comprising remediating the node identified as the root cause of the failure.

9. The method of claim 1, wherein the data path comprises a data path in a firewall.

10. A non-transitory machine-readable medium having program code stored thereon, the program code comprising instructions to:
detect a failure in a data path in a computing fabric, wherein the failure comprises a failure to send packets through the data path, wherein the data path comprises a plurality of nodes; and
traverse the data path in reverse order to identify a root cause of the failure, wherein traversing the data path in reverse order comprises, at each node in the plurality of nodes in the traversal,
modify packets to comprise packet headers with instructions to exit the data path at the node;
send the modified packets through the data path;
based on determining that the modified packets successfully exit the data path at the node, identify a subsequent node to the node in the data path as the node being the root cause of the failure; and
based on determining that the packets do not successfully exit the data path at the node, traverse to a preceding node in the data path.

11. The non-transitory machine-readable medium of claim 10 wherein the program code further comprises instructions to, at each node in the traversal, determine whether the modified packets successfully exit the data path at the node.

12. The non-transitory machine-readable medium of claim 11, wherein the instructions to send the modified packets through the data path comprise instructions to send the modified packets through the data path in kernel space, wherein the instructions to determine, at each node in the traversal, whether the modified packets successfully exit the data path at the node comprise instructions to determine, in user space, whether the modified packets successfully exit the data path at the node.

13. The non-transitory machine-readable medium of claim 11, wherein the instructions to determine, at each node in the traversal, whether the modified packets successfully exit the data path at the node comprise instructions to match signatures of packets exiting the data path at the node with signatures of the modified packets.

14. The non-transitory machine-readable medium of claim 10, wherein each node of the plurality of nodes comprises one or more chips.

15. The non-transitory machine-readable medium of claim 14, wherein the one or more chips comprise at least one of a central processing unit, an application-specific integrated circuit chip, a memory chip, and a network-on-chip.

16. An apparatus comprising:
in a data plane,
a computing fabric; and
in a control plane,
a processor; and
a machine-readable medium having instructions stored thereon that are executable by the processor to cause the apparatus to identify a root cause of failure in a data path of the computing fabric, wherein the instructions to identify the root cause of failure in the data path comprise instructions executable by the processor to cause the apparatus to,
detect a failure in a data path in a data plane, wherein the failure comprises a failure to send packets through the data path, wherein the data path comprises a plurality of nodes; and
traverse the data path in reverse order to identify a root cause of the failure, wherein traversing the data path in reverse order comprises, at each node in the plurality of nodes in the traversal,
modify packets as diagnostic to comprise packet headers with instructions to exit the data path at the node;
send the modified packets through the data path;
based on determining that the modified packets successfully exit the data path at the node, identify a subsequent node to the node in the data path as the node being the root cause of the failure; and
based on determining that the packets do not successfully exit the data path at the node, traverse to a preceding node in the data path.

17. The apparatus of claim 16, wherein t wherein the machine-readable medium further has stored thereon instructions executable by the processor to cause the apparatus to, at each node in the traversal, determining whether the modified packets successfully exit the data path at the node.

18. The apparatus of claim 17, wherein the instructions to send the modified packets through the data path comprise instructions executable by the processor to cause the apparatus to send the modified packets through the data path in kernel space, wherein the instructions to determine, at each node in the traversal, whether the modified packets successfully exit the data path at the node comprise instructions executable by the processor to cause the apparatus to determine, in user space, whether the modified packets successfully exit the data path at the node.

19. The apparatus of claim 17, wherein the instructions to determine, at each node in the traversal, whether the modified packets successfully exit the data path at the node comprise instructions executable by the processor to cause the apparatus to match signatures of packets exiting the data path at the node with signatures of the modified packets.

20. The apparatus of claim 16, wherein each node of the plurality of nodes comprises one or more chips.
